(19) United States
(12) Patent Application Publication
(10) Pub. No.: US 2005/0135100 A1
(43) Pub. Date: Jun. 23, 2005

(54) Christmas light bulb structure

(76) Inventor: Kang-Tien Lin, Hsinchu City (TW)

Correspondence Address: Troxell Law Office PLLC;Suite 1404, 5205 Leesburg Pike, Falls Church, VA, 22041, US

(21) Appl. No.: 10/736,524

(22) Filed: Dec. 17, 2003

(51) Int. Cl. F21V 14/00

(52) U.S. Cl. 362/255; 362/377; 362/378

(57) ABSTRACT

A light bulb structure includes a closed bulb receiving therein two magnesium wires connected with each other via a tungsten filament and an insulator connected to each of the two magnesium wires for separating the two magnesium wires, a closed lamp shade enclosing therein the bulb and allowing an extension of the two magnesium wires out of the lamp shade and a mounting base securely connected to a bottom of the lamp shade and allowing the two magnesium wires to extend out of the mounting base.

### BACKGROUND OF THE INVENTION

1. Field of the Invention

The present invention relates to a Christmas light bulb, and more particularly to a Christmas light bulb having a lamp shade securely mounted outside the light bulb and a cylindrical mounting socket mounted on the neck of the lamp socket such that two magnesium wires connected to each other by a tungsten filament are able to extend out of the light bulb, the lamp shade and the cylindrical mounting socket to have a connection with a power source.

2. Description of Related Art

Conventional decorative light bulbs are usually used to enhance festival atmosphere. Usually, the decorative light bulbs are hung on trees, laid on roof edges and many other places where the glamorous light beam will attract people's attention. However, there is a potential risk of using this decorative light bulbs in that the light bulb dissipate high temperature heat and the heat in contact with other materials such as trees, wallpapers and many others causes a fire easily. There are thousand of fires caused by this kind of incidents in a single year.

With reference to FIG. 4, a conventional light bulb (5) is shown and has two magnesium wires (6) connected to each other by a tungsten filament (7) and separated by an insulator (8). The two magnesium wires (6) extend out of the light bulb (5) for connection with a power source. This kind of light bulb (5) has nothing to isolate the heat generated by the tungsten filament (7) such that a fire is easily occurred when extra caution is not properly taken.

With reference to FIG. 5, a different light bulb assembly is shown and has a light bulb (5′) and a bulb socket (51) securely connected to a bottom of the light bulb (5′). Further, a lamp shade (9A) is mounted outside the light bulb (5′) and securely connected to a base (9B). It is noted that the lamp shade (9A) has an opening (9A′) defined to allow the extension of the bulb socket (51) out of the lamp shade (9A) such that the bulb socket (51) is received in the base (9B). With the isolation of the lamp shade (9A), the heat from the light bulb (5′) is greatly reduced to the damage to the environment. Still, there are disadvantages which cause the light bulb assembly not suitable for commercial use. First, the connection between the lamp shade (9A) requires additional assembly process, which results in additional expenses. Further, the lamp shade (9A) may fall off after a period of time.

To overcome the shortcomings, the present invention tends to provide an improved Christmas light bulb structure to mitigate the aforementioned problems.

### SUMMARY OF THE INVENTION

The primary objective of the present invention is to provide an improved Christmas light bulb structure having a light bulb enclosing therein two magnesium wires connected to each other via a tungsten filament and a lamp shade securely enclosing the light bulb and having the two magnesium wires extending out of the lamp shade for connection with a power source. Due to the connection between the lamp shade and the magnesium wires, the lamp shade is not going to fall off the Christmas light bulb after a period time of application.

Other objects, advantages and novel features of the invention will become more apparent from the following detailed description when taken in conjunction with the accompanying drawings.

### BRIEF DESCRIPTION OF THE DRAWINGS

FIG. 1 is a schematic plan view showing the lamp shade is enclosing therein the light bulb;

FIG. 2 is a schematic plan view showing the lamp shade is securely connected to the two magnesium wires extending out of the light bulb;

FIG. 3 is a schematic cross sectional view showing a base is provided to connect to a bottom of the lamp shade;

FIG. 4 is a plan view of a conventional light bulb; and

FIG. 5 is a schematic plan view showing a conventional light bulb assembly having a lamp shade outside the light bulb.

### DETAILED DESCRIPTION OF THE PREFERRED EMBODIMENT

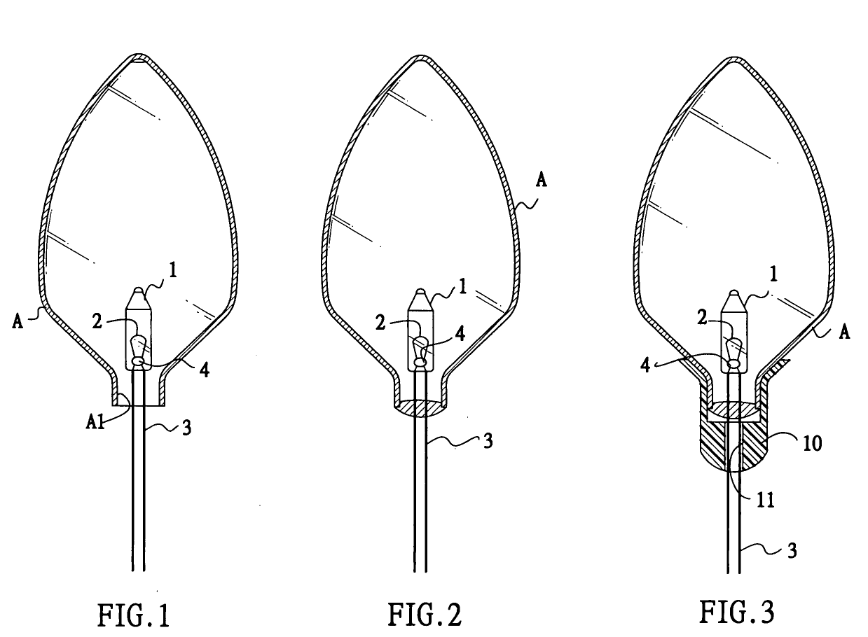

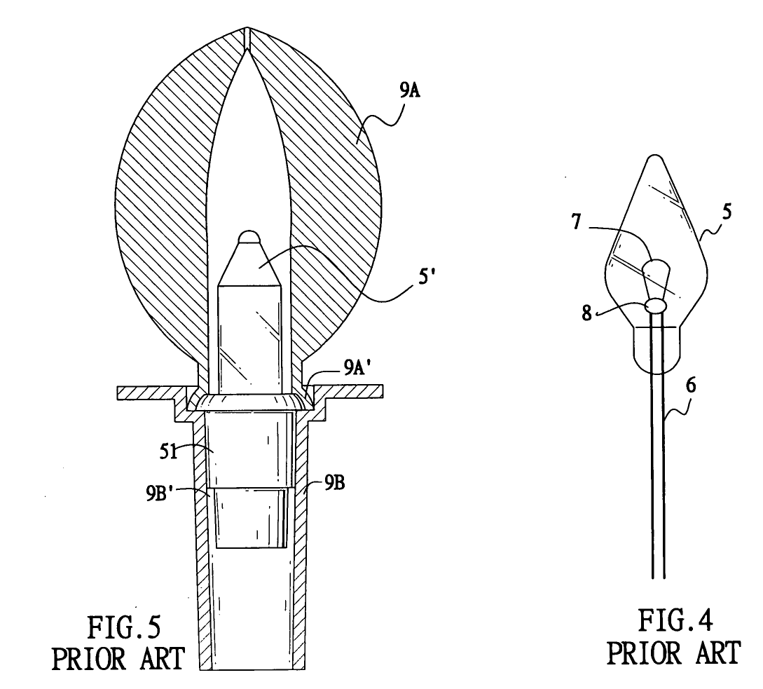

With reference to FIG. 1, the light bulb structure of the present invention has a bulb (1) enclosing therein two magnesium wires (3) connected to each other via a tungsten filament (2) and an insulator (4) separating the two magnesium wires (3) to prevent an electrical short. Further, a lamp shade (A) is provided outside the bulb (1) and has an opening (A1) to allow extension of the two magnesium wires (3).

With reference to FIG. 2, the opening (A1) of the lamp shade (A) is closed such that the lamp shade (A) is securely connected to each one of the two magnesium wires (3).

With reference to FIG. 3, after the opening (A1) of the lamp shade (A) is closed, a mounting base (10) is provided to support and connect to the lamp shade (A). the mounting base (10) has a passage (11) defined therein to correspond to and allow the extension of the two magnesium wires (3) for connection with a power source.

Because the lamp shade (A) is securely connected to the two magnesium wires (3) and the mounting base (10), the lamp shade (A) will not fall off from the light bulb structure of the present invention. Furthermore, the manufacture cost is greatly reduced in mass production of the light bulb structure of the present invention.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A light bulb structure comprising:
a closed bulb receiving therein two magnesium wires connected with each other via a tungsten filament and an insulator connected to each of the two magnesium wires for separating the two magnesium wires, wherein the two magnesium wires extends out of the bulb;
a closed lamp shade enclosing therein the bulb and allowing an extension of the two magnesium wires out of the lamp shade; and
a mounting base securely connected to a bottom of the lamp shade and allowing the two magnesium wires to extend out of the mounting base.

2. The light bulb structure as claimed in claim 1, wherein the mounting base has a passage correspond to the two magnesium wires such that the two magnesium wires are able to extend out of the mounting base.
